(19) United States
(12) Patent Application Publication
(10) Pub. No.: US 2024/0383326 A1
(43) Pub. Date: Nov. 21, 2024

(54) COOLANT RESERVOIR TANK

(71) Applicant: Hanon Systems, Daejeon (KR)

(72) Inventors: Seong Woo JEONG, Daejeon (KR); Jungbum CHOI, Daejeon (KR)

(21) Appl. No.: 18/704,306

(22) PCT Filed: Dec. 12, 2022
(86) PCT No.: PCT/KR2022/020147

§ 371 Date: Apr. 24, 2024

(30) Foreign Application Priority Data
Dec. 29, 2021 (KR) 10-2021-0190508

(51) Int. Cl. B60K 11/02; B60L 58/26

(52) U.S. Cl. CPC B60K 11/02; B60L 58/26

(57) ABSTRACT

The present invention relates to a coolant reservoir tank for a vehicle, and more particularly, to a reservoir tank, in which two reservoir tanks in the related art, which have been provided for respective cooling circuits, may be integrated into a single reservoir tank, and a single coolant injection port may be provided.

### TECHNICAL FIELD

The present invention relates to a coolant reservoir tank for a vehicle, and more particularly, to a reservoir tank, in which two reservoir tanks in the related art, which have been provided for respective cooling circuits, may be integrated into a single reservoir tank, and a single coolant injection port may be provided.

### BACKGROUND ART

An electric or hybrid vehicle is equipped with power electronic (PE) components including a motor, an inverter, an on-board charger (OBC), and the like. In addition, the electric or hybrid vehicle is equipped with a battery configured to provide electric power to the PE components.

Because the PE component and the battery generate heat while operating, the PE component and the battery need to be essentially cooled to protect the components and ensure durability. To this end, the electric or hybrid vehicle is equipped with a water-cooled PE cooling system for cooling the PE components and a water-cooled battery cooling system for cooling the battery.

Because the PE components and the battery are different in temperature ranges in main operating regions, i.e., the PE component operates at a relatively higher temperature than the battery, separate cooling systems are required for the PE components and the battery. Therefore, a PE cooling circuit for cooling the PE component by circulating a coolant through the PE component and a battery cooling circuit for cooling the battery by circulating a coolant through the battery are separately provided.

FIG. 1 is a view illustrating a cooling structure system for an electric vehicle in the related art. As illustrated, separate reservoir tanks R1 and R2 are independently provided for respective cooling circuits in order to operate separate cooling circuits. As described above, the electric vehicle in the related art is equipped with two reservoir tanks R1 and R2 used for the respective cooling circuits. However, it is difficult to mount the two reservoir tanks R1 and R2 in a narrow engine room, and the number of constituent elements increases, which causes a problem of an increase in manufacturing costs. In addition, the increase in number of constituent elements increases the weight, the increase in time required to mount the reservoir tanks degrades the productivity, and there is an inconvenience of having to perform maintenance separately on the respective cooling circuits.

### DOCUMENT OF RELATED ART

Korean Patent Application Laid-Open No. 10-2018-0099007 (published on Sep. 5, 2018)

### DISCLOSURE

### Technical Problem

The present disclosure has been made in an effort to solve the above-mentioned problem, and an object of the present invention is to provide a reservoir tank, in which two reservoir tanks in the related art, which have been provided for respective cooling circuits, may be integrated into a single reservoir tank, and a single coolant injection port may be provided.

### Technical Solution

A coolant reservoir tank for a vehicle according to an example of the present invention includes: a tank main body having a coolant injection part formed at an upper side thereof, the tank main body being configured to accommodate a coolant therein; a coolant passageway connected to the coolant injection part and extending into the tank main body; and a partition wall configured to divide an internal space of the tank main body into a first space and a second space, in which a distribution structure is provided to distribute the coolant, which is introduced into the coolant passageway, to the first space and the second space.

The coolant injection part may be configured as a single coolant injection part.

The distribution structure may include: a cup part having a cup shape in which the coolant introduced into the coolant passageway is collected; a first through-hole formed through the cup part and configured to allow the coolant passageway and the first space to communicate with each other; and a second through-hole formed through the cup part and configured to allow the coolant passageway and the second space to communicate with each other.

The first through-hole and the second through-hole may each be provided as one or more through-holes, and the one or more first through-holes and the one or more second through-holes may be symmetric with respect to a center of the cup part.

The cup part may include: a bottom portion positioned at a lower side of the cup part and configured to define a bottom; and an outer wall portion extending upward from the bottom portion and configured to define an outer wall, and the first through-hole and the second through-hole may be respectively formed in at least a part of the bottom portion and at least a part of the outer wall portion.

The cup part may include: a bottom portion positioned at a lower side of the cup part and configured to define a bottom; and an outer wall portion extending upward from the bottom portion and configured to define an outer wall, and the first through-hole and the second through-hole may each be elongated in an upward/downward direction along the outer wall portion.

The cup part may include: a bottom portion positioned at a lower side of the cup part and configured to define a bottom; and an outer wall portion extending upward from the bottom portion and configured to define an outer wall, and a connection portion, which connects the bottom portion and the outer wall portion, may define a curved surface convex toward the outside of the cup part.

The cup part of the distribution structure may be provided in the form of a circular cup.

The partition wall may have a dual wall structure having a hollow portion therein, and an air layer may be formed in the hollow portion.

The partition wall may have one or more through-holes formed through the partition wall to allow the first space and the second space to communicate with each other, and at least one through-hole may be disposed at an upper side based on a center of the partition wall based on an upward/downward direction.

The distribution structure and the partition wall may be integrated and connected to each other.

The coolant injection part, the distribution structure, and the partition wall may be positioned on the same line in an upward/downward direction.

A plurality of support beams may be provided in the tank main body and traverse the inside of the tank main body to support the tank main body.

### Advantageous Effects

The present invention may be implemented by integrating two reservoir tanks in the related art, which have been provided for respective cooling circuits, into a single reservoir tank. Therefore, it is possible to reduce a size and weight of the reservoir tank and manufacturing costs. Further, the coolant distribution structure may be provided, such that the single coolant injection port may be configured, which may provide the convenience for the maintenance of the coolant.

In addition, the partition wall has the dual wall structure in which the air layer is formed, such that the effect of thermally insulating the separated spaces in the tank may be maximized, thereby minimizing thermal interference between the coolants having different temperatures. Further, the support beam may be provided in the tank main body, which may ensure the structural durability of the reservoir tank.

### DESCRIPTION OF DRAWINGS

FIG. 1 is a view illustrating a cooling structure system for an electric vehicle in the related art.

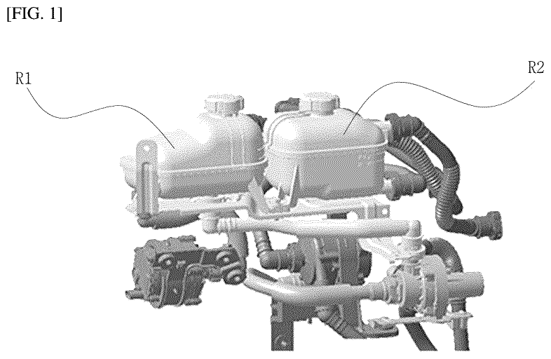

FIG. 2 is a front view of a reservoir tank according to an example of the present invention.

FIG. 3 is a vertical cross-sectional view of the reservoir tank in FIG. 2.

FIG. 4 is a view three-dimensionally illustrating an upper region of the reservoir tank in FIG. 3.

FIG. 5 is a view illustrating a distribution structure according to the example of the present invention when viewed from above.

FIG. 6 is a perspective view illustrating a part of the distribution structure of the reservoir tank when viewed from the lateral side.

FIG. 7 is a view simply illustrating the reservoir tank according to the example of the present invention.

FIG. 8 is a view three-dimensionally illustrating a lower region of the reservoir tank in FIG. 3.

### MODE FOR INVENTION

Hereinafter, the present invention will be described with reference to the accompanying drawings.

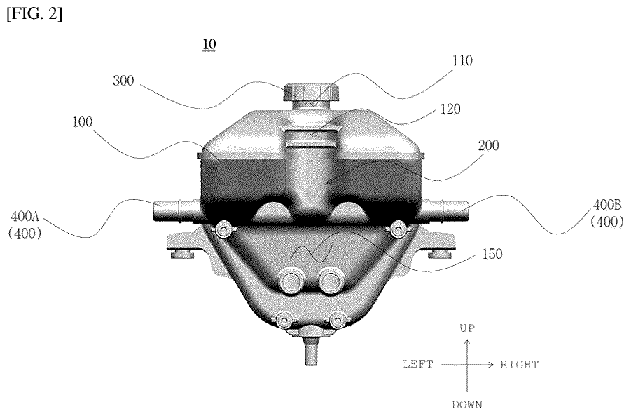

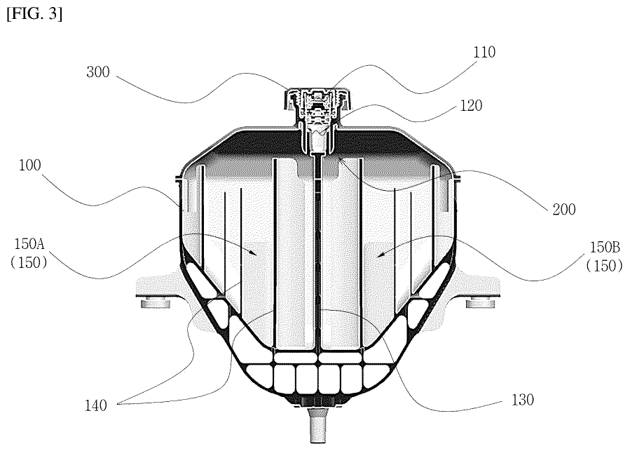

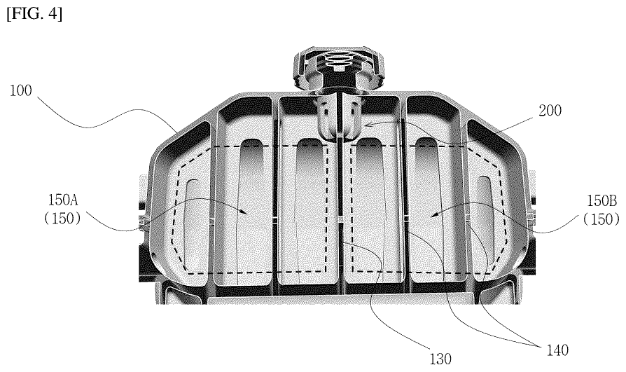

FIG. 2 is a front view of a reservoir tank according to an example of the present invention, FIG. 3 is a vertical cross-sectional view of the reservoir tank in FIG. 2, and FIG. 4 is a view three-dimensionally illustrating an upper region of the reservoir tank in FIG. 3. As illustrated, a reservoir tank 10 of the present invention may broadly include a tank main body 100 and further include a cap 300 configured to close a coolant injection part 110 provided at an upper side of the tank main body 100, and one or more coolant pipes 400 configured to allow an internal space of the tank main body 100 to communicate with the outside.

The tank main body 100 is an outer peripheral housing configured to accommodate and store a coolant. The coolant injection part 110 is provided at the upper side of the tank main body 100 so that the coolant may be introduced and supplemented through the coolant injection part 110. The tank main body 100 may have a hollow portion therein and accommodate the coolant. The coolant injection part 110 may be a through-hole formed at the upper side of the tank main body 100.

A coolant passageway 120, a partition wall 130, and a distribution structure 200 may be provided in the tank main body 100.

The coolant passageway 120 may be connected to the coolant injection part 110 at the upper side and extend to the inside of the tank main body 100. That is, as illustrated, the coolant passageway 120 may extend straight from the coolant injection part 110 and have the same cross-sectional area as the coolant injection part 110. The coolant passageway 120 may be a flow path provided in the form of a pipe. However, the coolant passageway 120 is not limited to the above-mentioned shape. The coolant passageway 120 may have a curved shape with a curved middle region or have a different cross-sectional area from the coolant injection part 110.

The partition wall 130 may partition an internal space of the tank main body 100 and divide the internal space of the tank main body 100 into a first space 150A and a second space 150B. As in the illustrated example, the partition wall 130 is positioned at a central portion of the internal space of the tank main body 100 and provided in an upward/downward direction, such that the partition wall 130 may divide the internal space of the tank main body 100 into left and right spaces.

That is, in the reservoir tank 10 of the present invention, the internal space of the tank main body 100 may be divided into the first space 150A and the second space 150B by the partition wall 150. The separated spaces 150A and 150B may constitute different cooling circuits. For example, the coolant in the first space 150A may circulate through a PE cooling circuit, and the coolant in the second space 150B may circulate through a battery cooling circuit. That is, the reservoir tank 10 of the present invention is configured by integrating separate reservoir tanks in the related art, which have been provided for respective cooling circuits to operate separate cooling circuits, into a single reservoir tank by using the partition wall 130 that bisects the internal space. Therefore, it is possible to solve the problem caused by the use of a plurality of reservoir tanks in the related art.

In this case, a configuration in which coolant injection parts are installed for respective spaces separated from one another may be considered to introduce and supplement the coolant. However, this configuration is disadvantageous in terms of manufacturing and management and may cause discomfort to a user because the cooling circuits need to be separately managed.

Therefore, in the present invention, only the single coolant injection part 110 may be provided, and the distribution structure 200 may be provided to appropriately distribute the coolant, which is introduced into the tank main body 100 through the coolant injection part 110, to the spaces 150A and 150B. That is, with reference back to FIGS. 3 and 4, only the single coolant injection part 110 may be provided at the upper side of the reservoir tank 10 of the present invention, and the distribution structure 200 may be provided to distribute the coolant, which is introduced into the coolant passageway 120 through the coolant injection part 110, to the first space 150A and the second space 150B. The distribution structure 200 may be disposed in the tank main body 100.

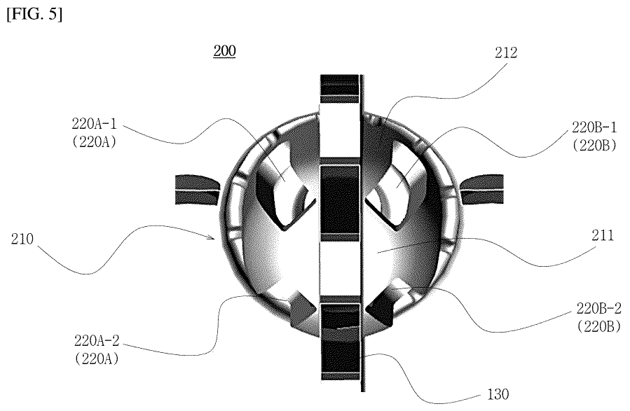

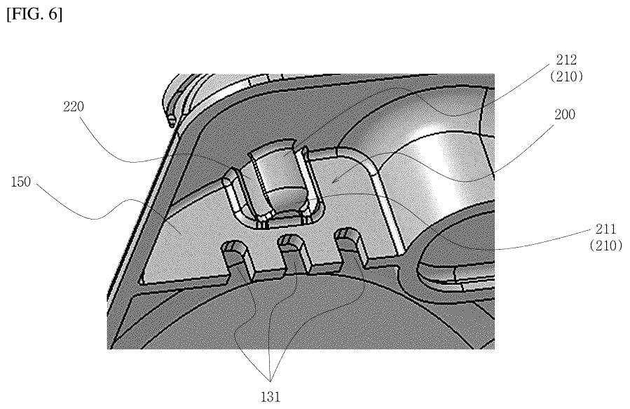

FIG. 5 is a view illustrating a distribution structure according to the example of the present invention when viewed from above, and FIG. 6 is a perspective view illustrating a part of the distribution structure of the reservoir tank when viewed from the lateral side. The distribution structure 200 of the present invention may include a cup part 210 and through-holes 220.

More specifically, the distribution structure 200 may have a structure in which one or more through-holes 220 are formed in the cup part 210 provided in the form of a cup in which the coolant, which is introduced into the coolant passageway 120 through the coolant injection part 110, is collected.

The cup part 210 may be a housing configured to surround the coolant passageway 120, and the coolant passageway 120 may be positioned in the cup part 210. More specifically, the cup part 210 may include a bottom portion 211 positioned at a lower side of the cup part 210 and configured to define a bottom, and an outer wall portion 212 extending upward from an outer edge of the bottom portion 211 and configured to define an outer wall.

In this case, the cup part 210 is formed in a circular cup shape. That is, as illustrated in FIGS. 5 and 6, the outer wall portion 212 of the cup part 210 may have a cylindrical shape so that an internal space thereof has a circular cross-section. All distances from a center of the cup part to the outer wall portion may be equal to one another, such that the coolant may be uniformly distributed in all directions in the cup part.

In addition, as illustrated in FIG. 6, a connection portion (not separately illustrated), which connects the bottom portion 211 and the outer wall portion 212 of the cup part 210, may be formed to define a curved surface convex toward the outside of the cup part 210. This may assist in preventing the coolant from remaining in the cup part and in preventing the coolant from being reversely introduced into the cup part from the outside of the cup part, i.e., the first or second space.

The through-hole 220 is a structure formed through the cup part 210 to allow the inside and outside of the cup part 210 to communicate with each other. The through-holes 220 may include first through-holes 220A formed through the cup part 210 and configured to allow the coolant passageway 120 and the first space 150A to communicate with each other, and second through-holes 220B formed through the cup part 210 and configured to allow the coolant passageway 120 and the second space 150B to communicate with each other. The positions of the through-holes 220, the number of through-holes 220, and the like are not limited. For example, the first through-hole 220A and the second through-hole 220B may be respectively formed in at least a part of the bottom portion 211 and at least a part of the outer wall portion 212 of the cup part. The first through-hole 220A and the second through-hole 220B may each be provided as a single through-hole or a plurality of through-holes.

With the distribution structure 200 of the present invention having the above-mentioned structure, the coolant injected into the coolant injection part 110 may be introduced and collected into the coolant passageway 120 corresponding to the inside of the cup part 210. At the same time, the coolant may pass through the first through-hole 220A and the second through-hole 220B and be distributed to the first space 150A and the second space 150B.

That is, in case that the single coolant injection part 110 is provided, there may occur a problem in that the coolant is introduced while being biased to the first space 150A and the second space 150B because of a state of the coolant to be injected into the coolant injection part 110, e.g., an injection rate, an injection amount, an injection angle, and the like of the coolant. Therefore, it is necessary to appropriately distribute the coolant into the two separated spaces 150A and 150B in the tank main body. According to the present invention, the distribution structure 200 may be provided to solve the above-mentioned problem and appropriately distribute the coolant into the respective spaces.

In this case, as illustrated in FIGS. 3 and 4, all the coolant injection part 110, the coolant passageway 120, the distribution structure 200, and the partition wall 130 may be positioned on the same line in an upward/downward direction. This arrangement may be an exemplary example in which the reservoir tank 10 may be configured in the simplest way. In addition, as illustrated, an upper side of the distribution structure 200 may be connected to an inner side of an upper surface of the tank main body 100. In other words, an upper side of the outer wall portion 212 of the distribution structure 200 may be connected directly to the inner side of the upper surface of the tank main body 100, such that the distribution structure 200 may surround the entire coolant passageway 120. Therefore, the entire coolant introduced into the coolant injection part 110 may be introduced into the distribution structure 200 and appropriately distributed into the two spaces through the distribution structure 200.

The distribution structure 200 will be described in more detail. The first through-hole 220A and the second through-hole 220B may each be provided as one or more through-holes. In this case, the one or more first through-holes 220A and the one or more second through-holes 220B may be symmetric with respect to the center of the cup part 210. As in the example in FIG. 5, the two first through-holes 220A and the two second through-holes 220B may be provided in the cup part 210. The two first through-holes 220A-1 and 220A-2 and the two second through-holes 220B-1 and 220B-2 may be spaced apart from one another at 90 degrees and disposed symmetrically with respect to the center of the cup part 210.

In this case, the configuration in which the first through-holes 220A and the second through-holes 220B are symmetric is provided to equally distribute the coolant to the first space 150A and the second space 150B. On the contrary, in case that a larger amount of coolant needs to be distributed to any one of the first space 150A and the second space 150B, the configuration may, of course, be appropriately designed and modified, like a configuration in which the number of first through-holes 220A and the number of second through-holes 220B may, of course, be different from each other, or a configuration in which the first through-hole 220A and the second through-hole 220B have different sizes.

In addition, as illustrated in FIG. 6, the through-hole 220, i.e., the first through-hole 220A and the second through-hole 220B may be elongated in the upward/downward direction along the outer wall portion 212. The through-hole, which is elongated in the upward/downward direction as described above, is advantageous in allowing the coolant to pass therethrough and also advantageous in that the plurality of through-holes may be formed in a circumferential direction of the outer wall portion of the cup part. In this case, the through-hole 220 may, of course, extend in the upward/downward direction from the outer wall portion 212 of the cup part 210 and be connected to at least a partial region of the bottom portion 211.

Meanwhile, with reference to FIG. 5, the distribution structure 200 may be configured such that the partition wall 130 traverses the internal space of the cup part 210. That is, the cup part 210 of the distribution structure 200 may include a pair of left and right structures, and the pair of left and right structures may be respectively coupled to left and right surfaces of the partition wall 130. This configuration is made in consideration of manufacturing convenience and the like. On the contrary, the internal space of the cup part 210 may be formed as an empty space, a groove may be formed at a position on the partition wall 130 corresponding to the cup part 210, and the cup part 210 may be accommodated in the corresponding groove.

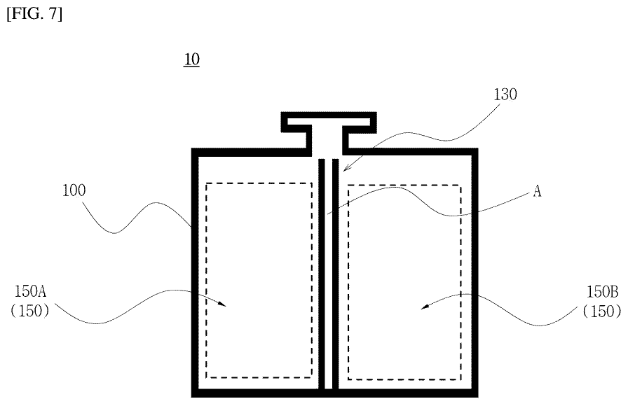

FIG. 7 is a view simply illustrating the reservoir tank according to the example of the present invention. As illustrated, the partition wall 130 may have a dual wall structure, and a space between walls of the dual wall structure may define a hollow portion in which an air layer may be formed. The partition wall 130 may be disposed between the first space 150A and the second space 150B. In this case, the coolant, which circulates in the first space 150A, and the coolant, which circulates in the second space 150B, may have different temperatures. That is, as described above, the coolant in the first space 150A may circulate through the PE cooling circuit, and the coolant in the second space 150B may circulate through the battery cooling circuit. In this case, the coolant in the first space 150A, which circulates through the PE cooling circuit, may have a relatively higher temperature than the second space 150B that circulates through the battery cooling circuit. In this case, in the present invention, the partition wall has the dual wall structure in which the air layer may be formed between the two walls, such that an thermal insulation effect of the partition wall may be maximized, and thus thermal interference between the coolant in the first space and the coolant in the second space may be minimized.

Further, the partition wall 130 may have one or more through-holes 131 formed through the partition wall 130. More specifically, with reference back to FIG. 6, the partition wall 130 may have the plurality of through-holes 131 formed through the partition wall 130 in a direction from the first space 150A toward the second space 150B in order to allow the first space 150A and the second space 150B to communicate with each other. This configuration is provided to equally maintain the amount of coolant at two opposite sides by sending the coolant from one space to the other space in case that the coolant is biased to any one of the first and second spaces when the coolant is injected or the cooling system operates. Therefore, the amount of coolant in the two spaces may be adjusted through the through-hole 131. To this end, the through-hole 131 may be positioned at an appropriate position. Particularly, as illustrated, the through-hole 131 may be disposed at an upper side based on a center of the partition wall 130 based on the upward/downward direction. This is related to a maximum coolant accommodation height (MAX) in the reservoir tank. The height of the through-hole may be equal to or higher than the maximum coolant accommodation height.

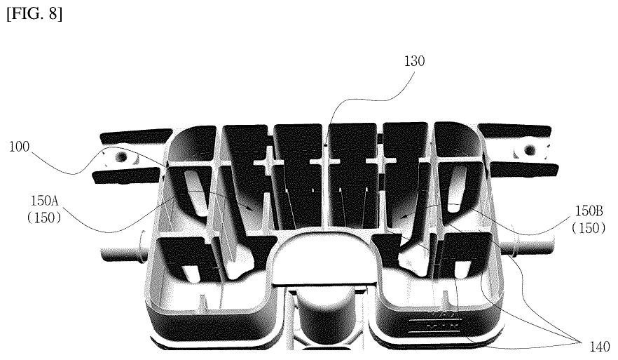

FIG. 8 is a view three-dimensionally illustrating a lower region of the reservoir tank in FIG. 3 and illustrates that the first space 150A and the second space 150B may be separated by the partition wall 130, and the coolant may be separately accommodated in the first space 150A and the second space 150B. In this case, as illustrated, a plurality of support beams 140 may be provided in the tank main body 100 and formed to traverse the inside of the tank main body 100 to support the tank main body 100.

The support beam 140 may be configured in the form of a flat plate shape having one end connected to one side surface in the tank main body 100, and the other end connected to the other side surface in the tank main body 100. The plurality of support beams 140 may perpendicularly intersect one another. In this case, at least a partial region of the support beam 140 may be opened or having a through-hole so that a space surrounded by the support beams 140 is not isolated, such that the internal space of the first space 150A and the internal space of the second space 150B may communicate with each other. The support beam 140 may be provided not only in the lower region of the tank main body 100 but also in the upper region of the tank main body 100, as illustrated in FIG. 4. In this case, although not illustrated, a partial region of the support beam 140 provided in the upper region of the tank main body 100 may, of course, be opened.

As described above, in the present invention, the plurality of support beams 140 may be provided in the tank main body 100, which may improve the structural durability of the reservoir tank.

As described above, the present invention may be implemented by integrating two reservoir tanks in the related art, which have been provided for respective cooling circuits, into a single reservoir tank. Therefore, it is possible to reduce a size and weight of the reservoir tank and manufacturing costs. Further, the coolant distribution structure may be provided, such that the single coolant injection port may be configured, which may provide the convenience for the maintenance of the coolant.

In addition, the partition wall has the dual wall structure in which the air layer is formed, such that the effect of thermally insulating the separated spaces in the tank may be maximized, thereby minimizing thermal interference between the coolants having different temperatures. Further, the support beam may be provided in the tank main body, which may ensure the structural durability of the reservoir tank.

While the embodiments of the present invention have been described with reference to the accompanying drawings, those skilled in the art will understand that the present invention may be carried out in any other specific form without changing the technical spirit or an essential feature thereof. Therefore, it should be understood that the above-described embodiments are illustrative in all aspects and do not limit the present invention.

### DESCRIPTION OF REFERENCE NUMERALS

10: Reservoir tank
100: Tank main body
110: Coolant injection part
120: Coolant passageway
130: Partition wall
131: Through-hole of partition wall
140: Support beam
150: Internal space of tank main body
150A: First space
150B: Second space
200: Distribution structure
210: Cup part
211: Bottom portion
212: Outer wall portion
220: Through-hole of cup part
220A: First through-hole
220B: Second through-hole
300: Cap
400: Coolant pipe

1. A coolant reservoir tank for a vehicle, the coolant reservoir tank comprising:
a tank main body having a coolant injection part formed at an upper side thereof, the tank main body being configured to accommodate a coolant therein;
a coolant passageway connected to the coolant injection part and extending into the tank main body; and
a partition wall configured to divide an internal space of the tank main body into a first space and a second space,
wherein a distribution structure is provided to distribute the coolant, which is introduced into the coolant passageway, to the first space and the second space.

2. The coolant reservoir tank of claim 1, wherein the coolant injection part is configured as a single coolant injection part.

3. The coolant reservoir tank of claim 2, wherein the distribution structure comprises:
a cup part having a cup shape in which the coolant introduced into the coolant passageway is collected;
a first through-hole formed through the cup part and configured to allow the coolant passageway and the first space to communicate with each other; and
a second through-hole formed through the cup part and configured to allow the coolant passageway and the second space to communicate with each other.

4. The coolant reservoir tank of claim 3, wherein the first through-hole and the second through-hole are each provided as one or more through-holes, and the one or more first through-holes and the one or more second through-holes are symmetric with respect to a center of the cup part.

5. The coolant reservoir tank of claim 3, wherein the cup part comprises:
a bottom portion positioned at a lower side of the cup part and configured to define a bottom; and
an outer wall portion extending upward from the bottom portion and configured to define an outer wall, and
wherein the first through-hole and the second through-hole are respectively formed in at least a part of the bottom portion and at least a part of the outer wall portion.

6. The coolant reservoir tank of claim 3, wherein the cup part comprises:
a bottom portion positioned at a lower side of the cup part and configured to define a bottom; and
an outer wall portion extending upward from the bottom portion and configured to define an outer wall, and
wherein the first through-hole and the second through-hole are each elongated in an upward/downward direction along the outer wall portion.

7. The coolant reservoir tank of claim 3, wherein the cup part comprises:
a bottom portion positioned at a lower side of the cup part and configured to define a bottom; and
an outer wall portion extending upward from the bottom portion and configured to define an outer wall, and
wherein a connection portion, which connects the bottom portion and the outer wall portion, defines a curved surface convex toward the outside of the cup part.

8. The coolant reservoir tank of claim 3, wherein the cup part of the distribution structure is provided in the form of a circular cup.

9. The coolant reservoir tank of claim 1, wherein the partition wall has a dual wall structure having a hollow portion therein, and an air layer is formed in the hollow portion.

10. The coolant reservoir tank of claim 1, wherein the partition wall has one or more through-holes formed through the partition wall to allow the first space and the second space to communicate with each other, and at least one through-hole is disposed at an upper side based on a center of the partition wall based on an upward/downward direction.

11. The coolant reservoir tank of claim 1, wherein the distribution structure and the partition wall are integrated and connected to each other.

12. The coolant reservoir tank of claim 1, wherein the coolant injection part, the distribution structure, and the partition wall are positioned on the same line in an upward/downward direction.

13. The coolant reservoir tank of claim 1, wherein a plurality of support beams is provided in the tank main body and traverses the inside of the tank main body to support the tank main body.
